(19) United States
(12) Patent Application Publication
(10) Pub. No.: US 2009/0194611 A1
(43) Pub. Date: Aug. 6, 2009

(54) Swirl Spray Nozzle and Insert Thereof

(76) Inventors: Frank Whittaker, Cheshire (GB); David Robert Percival, Cheshire (GB)

Correspondence Address: ANDRUS, SCEALES, STARKE & SAWALL, LLP, 100 EAST WISCONSIN AVENUE, SUITE 1100, MILWAUKEE, WI, 53202, US

(21) Appl. No.: 11/814,122

(22) PCT Filed: Jan. 17, 2006
(86) PCT No.: PCT/GB06/00135

§ 371 Date: Jul. 17, 2007

(30) Foreign Application Priority Data
Jan. 22, 2005 (GB) 0501401.4

(51) Int. Cl. B05B 1/34

(52) U.S. Cl. 239/490

(57) ABSTRACT

A spray nozzle swirl element (24) is described which includes a swirl chamber 38 and an integral retaining portion (26). Retainer means (28) are provided on the retaining portion (26) to allow the swirl element (24) to be retained, in use, in a nozzle body (10) of the associated spray nozzle.

This invention relates to a spray nozzle for use in forming a liquid into an atomised spray, and to components thereof. Although the nozzle could be used in a range of applications, the invention relates to a spray nozzle suitable for use in the spray drying industry.

A number of powdered products, for example powdered coffee or milk products or certain pharmaceutical materials, are formed by spraying a solution or suspension containing the product into a drying chamber. In the drying chamber the liquid evaporates and, provided the spraying operation produces droplets of a desired droplet size, this leaves the product in powdered form, the particles of the powder being of a desired size.

A spray nozzle used in such an application typically comprises a nozzle body housing an outlet orifice disc. The orifice disc is formed with a spray opening through which the liquid is delivered, in use. The nozzle body further includes a swirl element, the lower face of which is provided with a recess shaped to define a swirl chamber which communicates with the spray opening. The swirl element is of diameter smaller than the inner diameter of the nozzle body so as to define a flow path to allow the supply of fluid to the swirl chamber. A separate retainer disc is provided to secure the swirl element and orifice disc, and associated seals, in position. A nozzle of this type is described and illustrated in WO 03/068408.

During assembly, particularly where the nozzle is not orientated vertically as is often the case, difficulties can be faced in holding all of the components in their desired positions as, until the retainer disc is fitted, the swirl element and, sometimes, the outlet orifice disc are free to move within the nozzle body. Further, as the inner diameter of the nozzle body is machined to be larger than the outer diameter of the swirl element so as to form the flow path to the swirl chamber, the nozzle body is of increased dimensions and of reduced efficiency.

U.S. Pat. No. 2,904,263 describes an arrangement in which the swirl element diameter and inner diameter of the nozzle body are substantially equal, instead the fluid flowing into the swirl chamber in a direction substantially parallel to the axis of the nozzle. Although such an arrangement may allow a reduction in diameter, the liquid entry direction is thought to disrupt the flow of liquid through the swirl chamber, and so reduces the efficiency of the nozzle.

According to the present invention there is provided a swirl element for use in a spray nozzle, the swirl element including or defining a swirl chamber, and including an integral retaining portion adapted to be provided with retainer means to allow the swirl element to be retained, in use, in a nozzle body of the spray nozzle.

The retainer means may comprise an O-ring carried by the retaining portion.

The swirl element preferably defines a fluid supply path, conveniently including an enclosed region, located wholly within the diameter of the retaining portion, through which fluid is supplied in use, to the swirl chamber.

The fluid supply path is preferably defined, in part, by a peripheral recess formed in the swirl element, the swirl chamber communicating with the peripheral recess. The direction of fluid entry into the swirl chamber can then be substantially perpendicular to the axis of the nozzle which is much less disruptive to the fluid flow within the swirl chamber than when it enters in a direction substantially parallel to the nozzle axis.

According to another aspect of the invention there is provided a spray nozzle comprising a nozzle body, an orifice member and a swirl element located within the nozzle body, at least one of the swirl element and the orifice member including a retaining portion provided with retainer means to allow the swirl element and the orifice member to be retained within the nozzle body independently of other components of the spray nozzle.

By providing retainer means on the swirl element, and/or orifice member, assembly of the spray nozzle is simplified as there is no requirement to hold the swirl element and/or orifice member in position until a separate retainer disc is subsequently fitted.

The retainer means conveniently comprises an O-ring carried by the retaining portion and engageable with the wall of the nozzle body to retain the said at least one of the swirl element and the orifice member in position. The O-ring is conveniently engageable within a recess formed in the nozzle body. However, other forms of retainer means are envisaged.

The swirl element preferably includes a recess defining a swirl chamber, and formations defining a fluid supply path to the swirl chamber, the fluid supply path being located wholly within the diameter of the retaining portion.

Such an arrangement is advantageous in that the nozzle body can be of reduced diameter.

The fluid supply path is preferably defined, in part, by a peripheral recess formed in the swirl element, the swirl chamber communicating with the peripheral recess. The direction of fluid entry into the swirl chamber can then be substantially perpendicular to the axis of the nozzle which is much less disruptive to the fluid flow within the swirl chamber than when it enters in a direction substantially parallel to the nozzle axis.

The invention will further be described, by way of example, with reference to the accompanying drawings, in which:

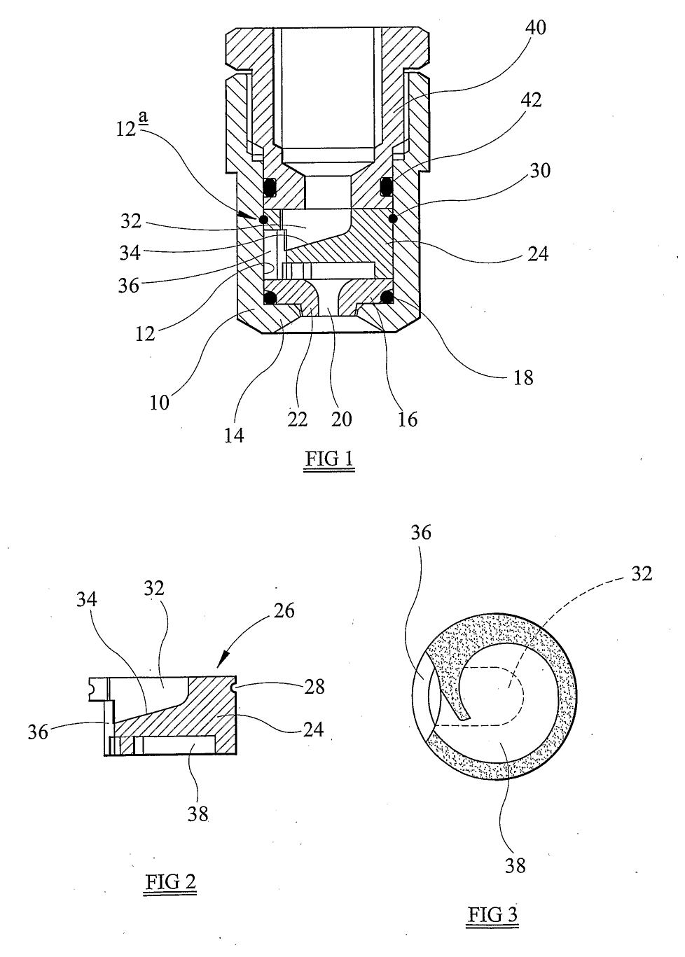

FIG. 1 is a cross-sectional view illustrating a spray nozzle including a swirl element in accordance with one embodiment of the invention;

FIG. 2 is a sectional view of part of the swirl element of the embodiment of FIG. 1;

FIG. 3 is a view of the swirl element from beneath;

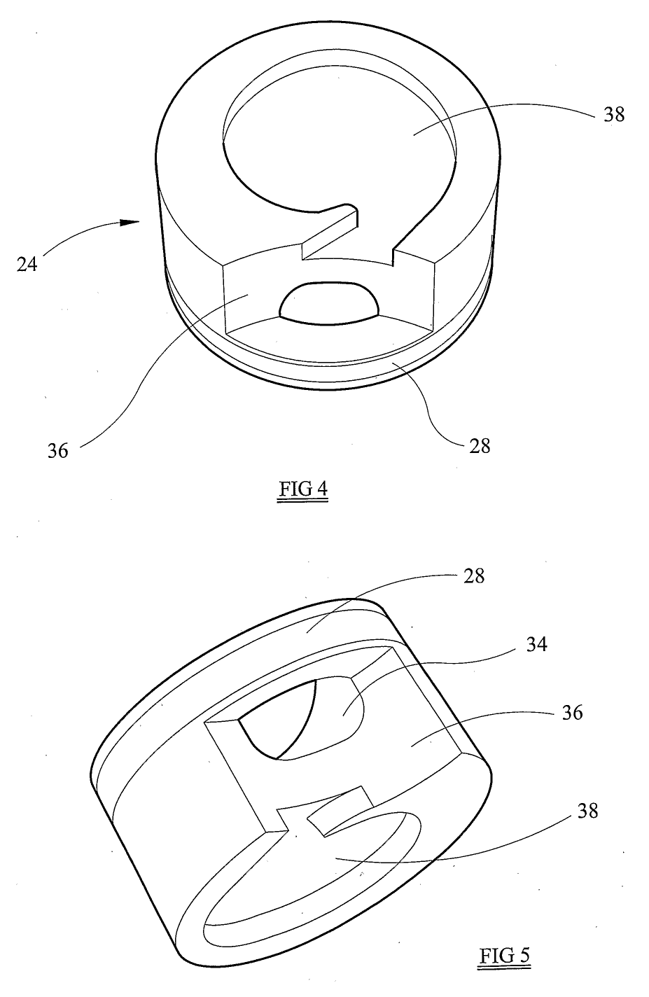

FIGS. 4 and 5 are perspective views of the swirl element; and

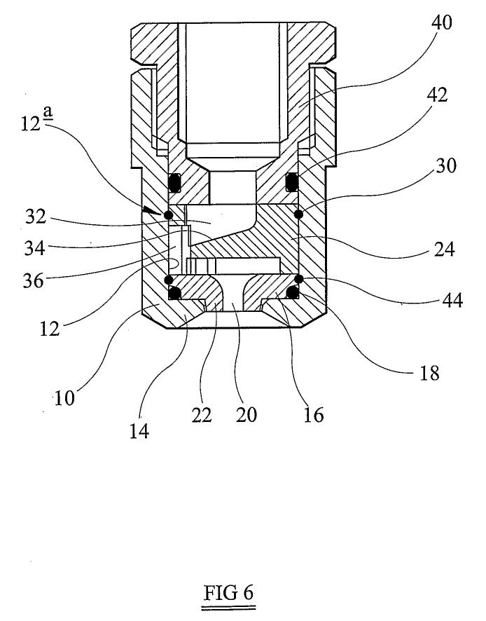

FIG. 6 is a view similar to FIG. 1 illustrating an alternative embodiment.

The spray nozzle illustrated in FIGS. 1 to 5 of the accompanying drawings comprises a nozzle body 10 of generally hollow cylindrical form and defining a bore 12. At one end of the nozzle body 10 is located an inwardly extending flange 14 which serves to support an orifice disc 16. An O-ring 18 or other seal arrangement is located between the orifice disc 16 and the wall of the nozzle body 10 to form a seal between these components.

The orifice disc 16 is formed with a centrally located outlet opening 20. Around the opening 20, the orifice disc 16 is shaped to define a lip 22. The presence of the lip 22 locally increases the thickness of the orifice disc 16 and thereby allows the inlet end of the orifice 20 to be of relatively large diameter.

Above the orifice disc 16, in the orientation illustrated in FIG. 1, is located a swirl element 24. The swirl element 24 is illustrated in greater detail in FIGS. 2 to 5. The swirl element 24 comprises a sintered body of generally cylindrical form having an outer diameter substantially equal to the diameter of the adjacent part of the bore 12 formed in the nozzle body 10. The upper end of the swirl element 24 defines a retaining portion 26, the outer periphery of which is formed with a recess 28 within which a retailing ring in the form of an O-ring 30 is located, in use. A corresponding recess 12a is formed in the wall of the bore 12 provided in the nozzle body 10 such that, in use, the O-ring 30 serves to locate and retain the swirl element 24 within the bore 12.

As shown in FIGS. 1 and 2, a recess 32 having a sloping bottom wall 34 is formed in the upper surface of the swirl element, in the orientation illustrated in FIGS. 1 and 2, the position and orientation of the recess 32 being such that it opens into a peripheral recess 36. The peripheral recess 36 does not extend over the full height of the swirl element 24, but rather only extends over the lower part of the swirl element 24, leaving the retaining portion 26 of circular cross-section. A swirl chamber is defined by a spiral shaped recess 38 provided in the lower surface of the swirl element 24, the swirl chamber communicating with the peripheral recess 36 and also with the outlet orifice 20 formed in the orifice disc 16. The recess 32 and peripheral recess 36 thus form a fluid flow path for supplying fluid to the swirl chamber, the fluid flow path including a portion defined by the recess 32 which is enclosed and wholly within the diameter of the swirl element 24.

Referring once again to FIG. 1, an adaptor member 40 is screw-fitted into the upper end of the nozzle body 10, an O-ring seal 42 carried by the adaptor member 40 forming a substantially fluid tight seal between the adaptor member 40 and the nozzle body 10.

In use, liquid is supplied through the bore of the adaptor member 40 to the recess 32 formed in the swirl element 24. The liquid flows from the recess 32 to the peripheral recess 36 and from there flows in a direction substantially perpendicular to the axis of the nozzle into the recess 38 defining the swirl chamber. The shape of the swirl chamber is such as to encourage the liquid to accelerate to a high speed and, subsequently, to leave the swirl chamber via the outlet orifice 20 formed in the orifice disc 16. The effect of this is to cause the liquid to form an atomised spray. Where used in a drying application, the nozzle is arranged such that the liquid supplied therethrough enters a drying chamber. In the drying chamber the liquid from the atomised spray evaporates leaving a residue in, for example, a powdered form. Although suitable for use in drying applications, it will be appreciated that the nozzle and the swirl element thereof could be used in other applications.

If the nozzle requires servicing or maintenance work to be conducted, then upon removal of the nozzle body 10 from the adaptor member 40, the swirl element 24 and orifice disc 16 are still held firmly within the nozzle body 10. Subsequently, a technician may remove the swirl element 24 from the nozzle body 10, for example by using a suitable tool to grip the swirl element 24 to allow servicing and/or replacement of the swirl element 24 and orifice disc 16. In order to reassemble the nozzle, the orifice disc 16 and associated seal 18 are introduced into the nozzle body 10. Subsequently, the swirl element 24 and O-ring 30 are introduced into the nozzle body and pushed into the nozzle body 10 until the O-ring 30 seats in the recess formed in the wall of the bore 12. In this position, the swirl element and orifice disc are secured to the nozzle body. Once assembled, the nozzle body 10 together with the swirl element 24 and orifice disc 16 can be secured to the adaptor member 40 and tightened to achieve a desired compressive load on the O-ring 18 and the O-ring seal 42.

It will be appreciated that the nozzle described hereinbefore is advantageous in that no separate retaining ring or other retainer device need be used to secure the swirl element in position. Rather, the retaining portion is integral with the remainder of the swirl element. As a result, the assembly procedure and servicing and maintenance of the nozzle is simplified. Further, the flow path for liquid through the swirl element to the swirl chamber includes a portion which is located wholly within the diameter of the retaining portion 26 of the swirl element 24 thus the necessity to provide a bore in the nozzle body of increased diameter to form the flow path to the swirl chamber is avoided. As a result the nozzle can be of reduced dimensions. Further, the flow path is orientated such that the direction in which fluid enters the swirl chamber is substantially perpendicular to the axis of the nozzle. As the change in fluid flow direction from substantially parallel to the nozzle axis to substantially perpendicular thereto occurs outside of the swirl chamber, the fluid entry into the swirl chamber is much less disruptive to the swirling action of the flow of fluid through the swirl chamber thereby resulting in improved efficiency of the nozzle and a more uniform spray output from the nozzle.

In a modification to the above arrangement illustrated in FIG. 6, the orifice disc 16 may be provided with a recess within which an O-ring 44 or other retainer is located, the O-ring 44 being receivable within a corresponding recess formed in the nozzle body 10 to allow the orifice disc 16 to be retained within the nozzle body independently of other components of the nozzle. This modification may be used either alone or in conjunction with the provision of a retainer means on the swirl element (as shown).

Although the arrangement hereinbefore makes use of an O-ring to retain the swirl element within the nozzle body, it will be appreciated that other components could be used to achieve this function. A range of other modifications and alterations may be made to the spray nozzle described hereinbefore without departing from the scope of the invention.

1. A swirl element for use in a spray nozzle, the swirl element including or defining a swirl chamber, and including an integral retaining portion adapted for use with retainer means to allow the swirl element to be retained, in use, in a nozzle body of the spray nozzle.

2. A swirl element according to claim 1, wherein the retainer means comprises an O-ring carried by the retaining portion.

3. A swirl element according to claim 1, wherein the swirl element defines a fluid supply path through which fluid is supplied in use, to the swirl chamber.

4. A swirl element according to claim 3, wherein the fluid supply path includes an enclosed region, located wholly within the diameter of the retaining portion.

5. A swirl element according to claim 3, wherein the fluid supply path is defined, in part, by a peripheral recess formed in the swirl element, the swirl chamber communicating with the peripheral recess.

6. A swirl element according to claim 1 wherein the periphery of the integral retaining portion is of unbroken, smoothly curved form.

7. A swirl element according to claim 6, wherein the integral retaining portion is of circular cross-sectional shape.

8. (canceled)

9. A spray nozzle comprising a nozzle body, an orifice member and a swirl element located within the nozzle body, at least one of the swirl element and the orifice member including a retaining portion provided with retainer means to allow the swirl element and the orifice member to be retained within the nozzle body independently of other components of the spray nozzle.

10. A nozzle according to claim 9, wherein the retainer means comprises an O-ring carried by the retaining portion and engageable with the wall of the nozzle boxy to retain the said at least one of the swirl element and the orifice member in position.

11. A nozzle according to claim 10, wherein the O-ring is engageable within a recess formed in the nozzle body.

12. A nozzle according to claim 9, wherein the swirl element includes a recess defining a swirl chamber, and formations defining a fluid supply path to the swirl chamber, the fluid supply path being located wholly within the diameter of the retaining portion.

13. A nozzle according to claim 12, wherein the fluid supply path is defined, in part by a peripheral recess formed in the swirl element, the swirl chamber communicating with the peripheral recess.

14. (canceled)
